(19) United States
(12) Patent Application Publication
(10) Pub. No.: US 2012/0265594 A1
(43) Pub. Date: Oct. 18, 2012

(54) SETTLEMENT PROCESSING APPARATUS, METHOD AND SYSTEM

(75) Inventor: Makiko Terabayashi, Izunokuni-shi (JP)

(73) Assignee: TOSHIBA TEC KABUSHIKI KAISHA, Tokyo (JP)

(21) Appl. No.: 13/424,600

(22) Filed: Mar. 20, 2012

(30) Foreign Application Priority Data
Apr. 18, 2011 (JP) 2011-092073

(51) Int. Cl. G06Q 30/02

(52) U.S. Cl. 705/14.23

(57) ABSTRACT

A settlement processing apparatus comprises: an information input unit configured to input commodity-related information; a total amount calculation unit configured to calculate the total amount of the costs of the information-input commodities; a discount indication unit configured to indicate the execution of a discount of a predetermined class; a discount amount calculation unit configured to calculate a discount amount by multiplying the calculated total amount by a given discount rate if the discount indication unit indicates the execution of a discount; and a history storage unit configured to store the calculated discount amount for being able to identify the class of the discount, if the settlement of the commodity or service which is input the information by the information input unit is completed.

### CROSS-REFERENCE TO RELATED EXECUTION

This execution is based upon and claims the benefit of priority from Japanese Patent Execution No. 2011-092073, filed Apr. 18, 2011, the entire contents of which are incorporated herein by reference.

### FIELD

Embodiments described herein relate to a settlement processing apparatus, method and system used for the settlement of a commodity or service as a trade object.

### BACKGROUND

At present, a settlement processing apparatus such as a POS (Point Of Sales) is used to realize the settlement of the commodities or services in a shop.

Such settlement processing apparatuses include an apparatus which has a function of calculating a discount amount for the total amount of the commodities or services purchased by a customer.

### BRIEF DESCRIPTION OF THE DRAWINGS

FIG. 1 is a block diagram showing the main components of a POS terminal according to an embodiment;

FIG. 2 is a diagram illustrating an example of the data structure of a PLU (Price Look Up) master according to the embodiment;

FIG. 3 is a diagram illustrating an example of the data structure of a discount setting file according to the embodiment;

FIG. 4 is a diagram illustrating an example of the data structure of a sales file according to the embodiment;

FIG. 5 is a flow chart of a settlement processing according to the embodiment;

FIG. 6 is a flow chart of a first specific example of a settlement processing according to the embodiment;

FIG. 7 is a diagram showing a receipt issued in the first specific example according to the embodiment;

FIG. 8 is a flow chart of a second specific example of a settlement processing according to the embodiment;

FIG. 9 is a diagram showing a receipt issued in the second specific example according to the embodiment;

FIG. 10 is a flow chart of a third specific example of a settlement processing according to the embodiment;

FIG. 11 is a flow chart of a totalizing processing according to the embodiment;

FIG. 12 is a diagram illustrating a settlement processing system according to the other embodiment.

### DETAILED DESCRIPTION

According to one embodiment, a settlement processing apparatus, comprising: an information input unit configured to input the information related to a commodity or service; a total amount calculation unit configured to calculate the total amount of the costs of the commodities or services which is input the information by the information input unit; a discount indication unit configured to indicate the execution of the discount according to predetermined class; a discount amount calculation unit configured to calculate a discount amount by multiplying the total amount calculated by the total amount calculation unit by a given discount rate, if the discount indication unit indicates the execution of the discount; and a history storage unit configured to store the discount amount calculated by the discount amount calculation unit for being able to identify the class of the discount, if the settlement of the commodity or service which is input the information by the information input unit is completed.

An embodiment is described below.

A POS terminal 1 used in a shop is further given in this embodiment as an example of the settlement processing apparatus.

[POS terminal1]

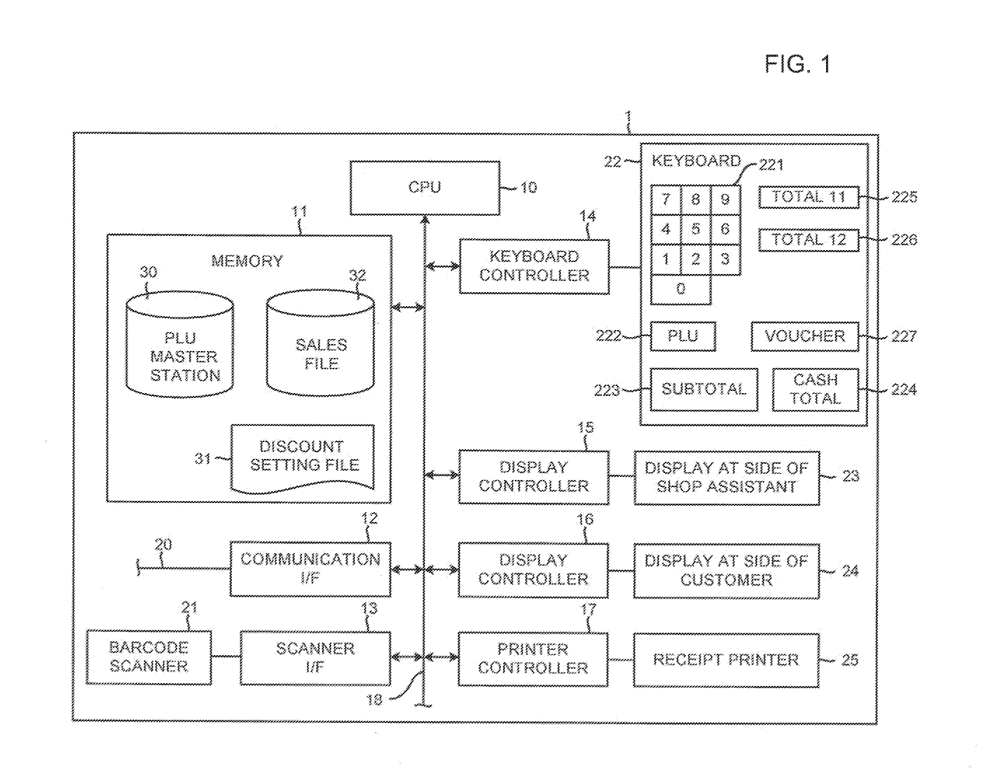

FIG. 1 is a block diagram showing the main components of the POS terminal 1 described in this embodiment.

The POS terminal 1 has a CPU (Central Processing Unit) 10 serving as a control center. This CPU 10 is connected with a memory 11, a communication I/F (Interface) 12, a scanner I/F 13, a keyboard controller 14, display controllers 15 and 16 and a printer controller 17 via a bus line 18 consisting of address or data bus lines.

In addition, the communication line 20 such as the LAN (Local Area Network) line in a shop is connected with the communication I/F 12, a barcode scanner 21 is connected with the scanner I/F 13, a keyboard 22 is connected with the keyboard controller 14, a display 23 at the side of a shop assistant is connected with the display controller 15, a display 24 at the side of a customer is connected with the display controller 16, and a receipt printer 25 is connected with the printer controller 17.

The computer program executed by the CPU 10 to execute the settlement processing below, fixed data including various fixed values, a PLU master 30, a discount setting file 31 and a sales file 32 are stored in the memory 11 consisting of an ROM (Read Only Memory) or RAM (Random Access Memory). Further, if the POS terminal 1 is accessible, then the PLU master 30, the discount setting file 31 and the sales file 32 can also be stored in another memory medium, such as an external memory medium or a memory provided in a machine connected with the POS terminal 1.

The communication I/F 12 transmits data between machines (e.g. servers or printers) communicating with each other via the communication line 20.

The barcode scanner 21 optically reads the barcode attached on a commodity and generates a PLU code. The scanner I/F 13 acquires the code information generated by the barcode scanner 21 and outputs the acquired code information to the CPU 10.

The keyboard 22, consists of a numeric keypad 221 which consists of a numeric keys of 0-9, a PLU key 222 indicating start of a settlement processing, a subtotal key 223 indicating the execution of a subtotal calculation, a cash total key 224 indicating the completion of a settlement processing of cash, a total 11 key 225 and a total 12 key 226 indicating the execution of a discount for the total amount of a transaction and a voucher key 227 announcing the use of a voucher, outputs a signal representing a key pressed. The keyboard controller 14 acquires the signal output from the keyboard 22 and outputs the acquired signal to the CPU 10.

Further, the discount applied by operating the total 11 key 225 and total 12 key 226 are referred to as ‘an automatic discount’ in the description below.

The display 23 at the side of a shop assistant consists of, for example, an LCD (Liquid Crystal Display) the display side of which faces the position where the shop assistant stands and a touch panel arranged on the display side of the LCD. The display controller 15 controls the display 23 at the side of a shop assistant according to an instruction from the CPU 10 and displays a settlement processing screen on the LCD. Further, the display controller detects a GUI display on the LCD according to the signal output when the touch panel is touched and informs the CPU 10 of the result of the detection.

The display 24 at the side of a customer is, for example, an LED display the display side of which faces the standing position of the customer receiving a calculation result. The display controller 16 controls the display 24 at the side of a customer to display the cost of each commodity purchased by the customer, the total costs of the commodities and a charge amount.

The receipt printer 25 is, for example, a thermal printer printing various kinds of information on a piece of thermal receipt paper. The printer controller 17 controls the actions of the receipt printer 25 to issue a receipt on which the names or unit prices, subtotal amounts, the total amount and the discount amount of the commodities purchased by a customer are printed.

[Data structure]

The data structures of the PLU master 30, the discount setting file 31 and the sales file 32 are described below.

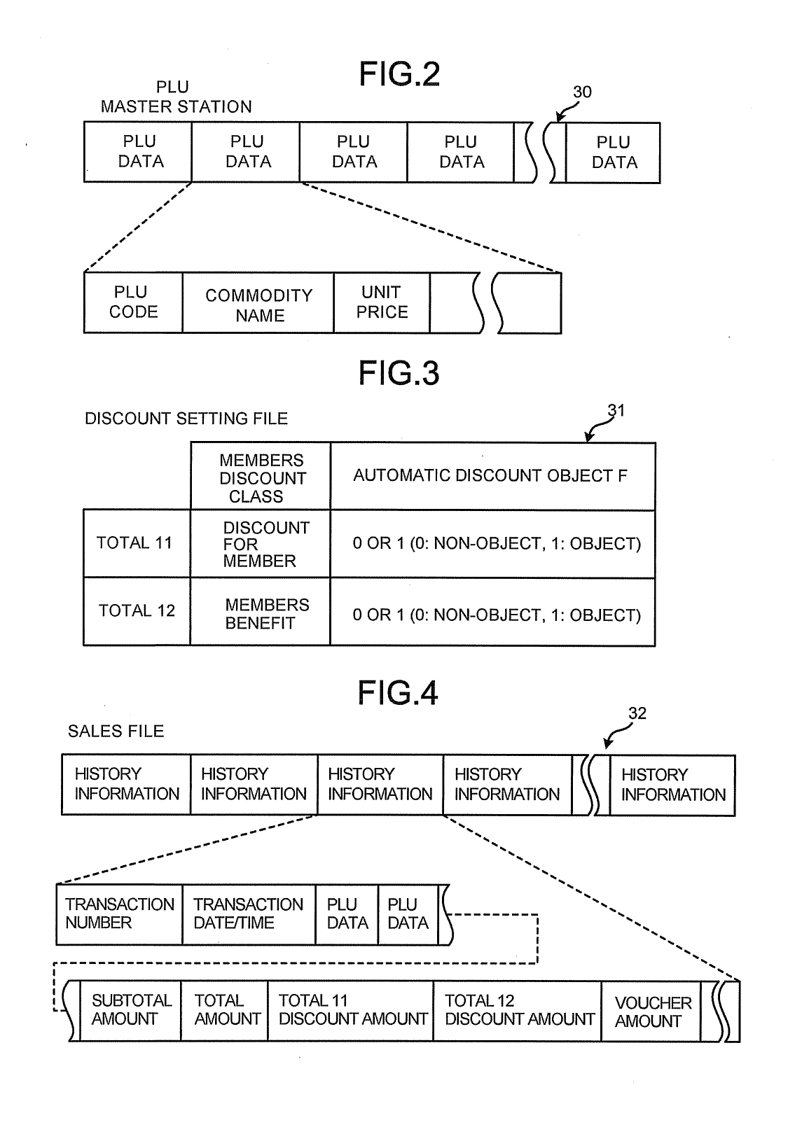

FIG. 2 is a diagram illustrating an example of the data structure of the PLU master 30.

The PLU master 30 is composed of the PLU data of each commodity sold in a shop installed with the POS terminal 1. Each PLU data is composed of a PLU code uniquely distributed to a commodity, a commodity name representing the name of a commodity and a unit price representing the selling price of a commodity.

FIG. 3 is a diagram illustrating an example of the data structure of the discount setting file 31.

The discount setting file 31 consists of the history corresponding to the total 11 key 225 and the total 12 key 226. A discount class and an automatic discount object flag F (hereinafter referred to as flag F) of an automatic discount object are described in each history. The flag F is set to be ‘0’ (non-object) or ‘1’ (object). If the flag F is ‘1’, then the discount indicated by a discount class is achieved in the later-described settlement processing by operating the keys, and if the flag F is ‘0’, then the discount indicated by a discount class is not applied. It is assumed in this embodiment that a discount class ‘discount for member’ is set on the total 11 key 225 and a discount class ‘benefit for member’ is set on the total 12 key 226. Further, it is also assumed herein the flag F is set to be ‘1’.

The discount setting file 31 with the structure above is compiled, for example, in a discount setting processing executed by the POS terminal 1. That is, in the discount setting processing, the discount classes set for keys 225 and 226 and the input value of the flag F are accepted, and the content of the discount setting file 31 is updated in the input discount class and the value of the flag F.

FIG. 4 is a diagram illustrating an example of the data structure of the sales file 32.

The sales file 32 consists of the history information of the history in the transactions settled by the POS terminal 1. Each of history information is consisted of ‘a transaction number’ and ‘a transaction date and time’ distributed to each transaction, ‘a PLU data’ of each commodity settled in the transaction and ‘a subtotal amount’ and ‘a total amount’ of the transaction.

Further, an item ‘total 11 discount amount’ is added in the history information if a discount based on an operation on the total 11 key 225 is applied, and an item ‘total 12 discount amount’ is added in the history information if a discount based on an operation on the total 12 key 226 is applied. Further, an item ‘voucher amount’ is added in the history information if a voucher is used. In this way, an item corresponding to the class of a price discount is added if a price discount is applied to the total amount, and the amount of the price discount is written, thus, the amount of a price discount applied in a transaction and the class of the price discount can be identified.

[Settlement processing]

Next, the settlement processing carried out by the POS terminal 1 for the purchased commodities is described below.

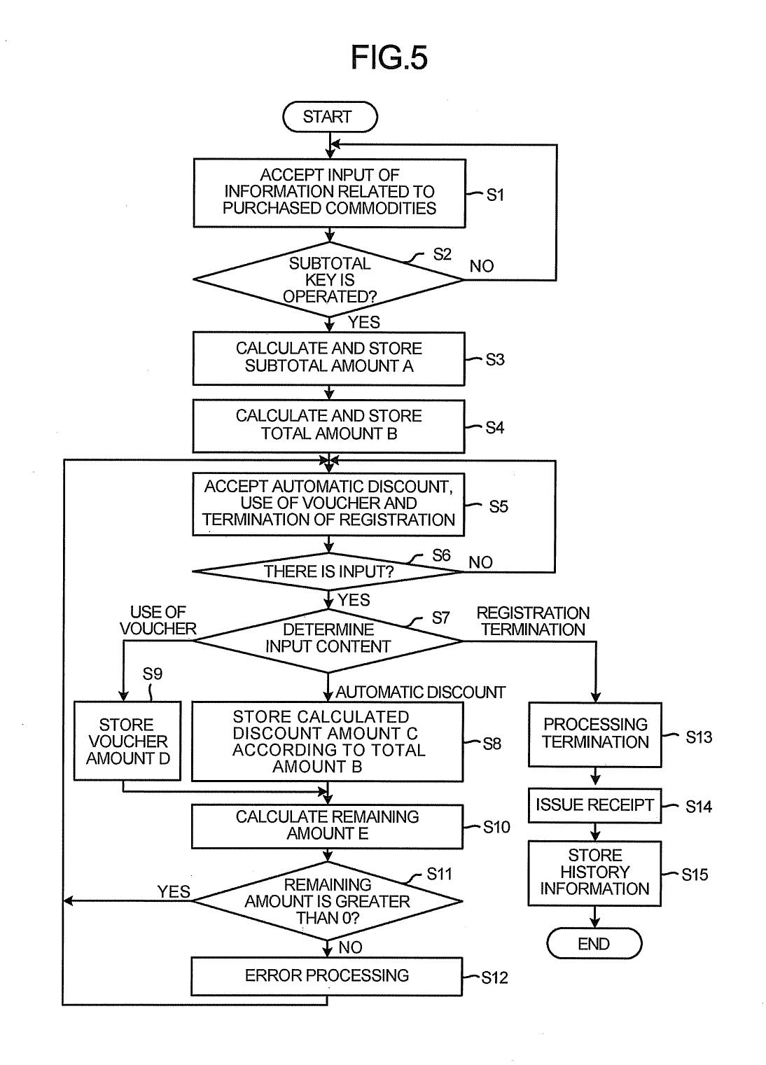

If the PLU key 222 is operated, then the CPU 10 acts in accordance with the settlement processing stored in the memory 11 to realize the flow shown in FIG. 5.

That is, the CPU 10 first receives the input of the information related to the commodities purchased by the customer, namely, the input of a PLU code (Act S1), and at the same time, waits for an operation on the subtotal key 223 (Act S2).

At this time, the PLU code of the purchased commodity can be input by scanning a barcode with the barcode scanner 21, or operating the keyboard 22 or a preset key on the display 23 or at the side of a shop assistant. After the PLU code is input, the CPU 10 retrieves the PLU master 30 to look for data containing the PLU code, and writes the found PLU data in a transaction buffer (not shown) arranged in the memory 11.

Then, if the PLU codes of the commodities purchased by a customer are all input in one transaction, the shop assistant operating the POS terminal 1 operates the subtotal key 223 (Act S2: Yes). At this time, the CPU 10 calculates a subtotal amount A and a total amount B according to the PLU data written in the transaction buffer and stores the calculated amounts in the transaction buffer (Acts S3 and S4). Further, the subtotal amount A is calculated by summating the unit prices contained in the PLU data written in the transaction buffer, and the total amount B is calculated by adding an additional tax amount to the total amount B. It is assumed in this embodiment that the unit prices contained in the PLU data are all represented with tax included price, the subtotal amount A and the total amount B are the same. In this case, the total amount B calculated becomes a fixed amount that is unchanged with a discount.

After the total amount B is calculated, the CPU 10 enters into a state in which the CPU 10 can accept an indication of the execution of an automatic discount, the announcement of the use of a voucher and an indication of the execution of a registration termination (Act S5) to wait for the input of the contents above (Act S6).

The execution of an automatic discount is indicated by keys 225 and 226 after a discount rate is input by operating the number key 221. It is assumed in this embodiment that the flags F in the discount setting file 31 are all ‘1’, however, an indication input by operating the keys to indicate the execution of an automatic discount can be deemed invalid when the flag F is ‘0’.

Further, the announcement of the use of a voucher is indicated by operating the voucher key 227 after the amount of the voucher is input by operating the numeric keypad 221. Further, the execution of a registration termination is indicated by operating the cash total key 224 after a given amount from the customer is input by operating the numeric keypad 221. Further, in this embodiment, the commodities are exemplarily settled with cash; however, the commodities can also be settled with a credit card or electronic money. If commodities are settled with a credit card or electronic money, a key is arranged on the keyboard 22 to indicate a settlement with a credit card or electronic money, and the execution of a registration termination can also be indicated by operating the key.

If an input is completed in Act S5 (S6: Yes), then the CPU 10 determines the input content (Act S7). If the input content is an indication of the execution of an automatic discount (the automatic discount described in Act 7), then the CPU 10 calculates a discount amount C according to the total amount B and stores the calculated discount amount C in the transaction buffer (Act S8)

Here, the discount amount of the automatic discount indicated by the operated total 11 key 225 is defined as total 11 discount amount C1, and that of the automatic discount indicated by the operated total 12 key 226 is defined as total 12 discount amount C2. If the automatic discount execution indication received in Act S5 is an indication based on an operation on total 11 key 225, then the CPU 10 multiplies the total amount B by the discount rate input in Act S5 and takes the calculated amount as the total 11 discount amount C1 in Act 8. On the other hand, if the automatic discount execution indication received in Act S5 is an indication based on an operation on total 12 key 225, the CPU 10 multiplies the total amount B by the discount rate input in Act S5 and takes the calculated amount as the total 12 discount amount C2 in Act 8.

If the content input in Act S5 is the announcement of the use of a voucher (the use of a voucher described in S7), then the CPU 10 stores the amount input in S5 in the transaction buffer as a voucher amount D (Act S9)

After Act S8 or S9 is executed, the CPU 10 calculates a remaining amount E (Act 10). The remaining amount E is calculated by subtracting the one of the total 11 discount amount C1, the total 12 discount amount C2 and the voucher amount D written in the transaction buffer from the total amount B written in the transaction buffer. After calculating the remaining amount E, the CPU 10 determines whether or not the remaining amount E is greater than 0 (Act S11). If the remaining amount E is greater than 0 (Act11: Yes), the CPU 10 returns to Act S5 and under the state that the CPU 10 can accept the indication of the execution of an automatic discount, the announcement of the use of a voucher and an indication of the execution of a registration termination to wait for the input of the contents above.

On the other hand, if the remaining amount E is smaller than 0 (Act 11: No), that is, the discount amount is greater than the total amount B, then, the CPU 10 displays an alarm message on the display 23 at the side of a shop assistant to notify an error and then deletes the total 11 discount amount C1 or the total 12 discount amount C2 or the voucher amount D written in the transaction buffer in the previous Act S8 or S9 (Act S12). Then, the CPU 10 returns to execute Act S5 to enter into the state in which the CPU 10 can accept an indication of the execution of an automatic discount, the announcement of the use of a voucher and an indication of the execution of a registration termination to wait for the input of the contents above.

Here, if the content input in Act 5 is the indication of a registration termination ('registration termination' described in S7), then the CPU 10 executes of the termination processing (Act S13). In the processing of the termination, the CPU 10 subtracts the total 11 discount amount C1 or the total 12 discount amount C2 or the voucher amount D written in the transaction buffer from the total amount B written in the transaction buffer, and subtracts the amount of the result of above subtraction from the deposit amount which is input in the processing in Act S5, and displays the change amount of the result of above subtraction on the display 23 of the side of a shop assistant or the display 24 of the side of a customer and opens a drawer (not shown).

Further, the CPU 10 makes the receipt printer 25 issue the receipt on which printed the PLU data written in the transaction buffer, the subtotal amount A, the total amount B, the total 11 discount amount C1, the total 12 discount amount C2, the voucher amount D, the transaction number of the said transaction, the transaction date and time and the like (Act S14).

Moreover, the CPU 10 generates the history information of the transaction, stores the history information in the sales file 32 (Act S15), and then ends the settlement processing.

For the history information generated in Act S15, the transaction number of the said transaction, the current date and time, each PLU data written into the transaction buffer, the subtotal amount A and the total amount B are respectively written in the items shown in FIG. 4, that is to say, in each items of ‘the transaction number’, ‘the transaction date and time’, ‘the PLU data’, ‘the subtotal amount’ and ‘the total amount’, in addition, if a discount based on an operation of the total 11 key 225 is executed, an item of ‘the total 11 discount amount’ is added, and is written in the total 11 discount amount C1, if a discount based on an operation of the total 12 key 226 is executed, an item of ‘the total 12 discount amount’ is added and the total 12 discount amount C2 is written, and if a voucher is used, the item of ‘the voucher amount’ is added and the voucher amount D is written.

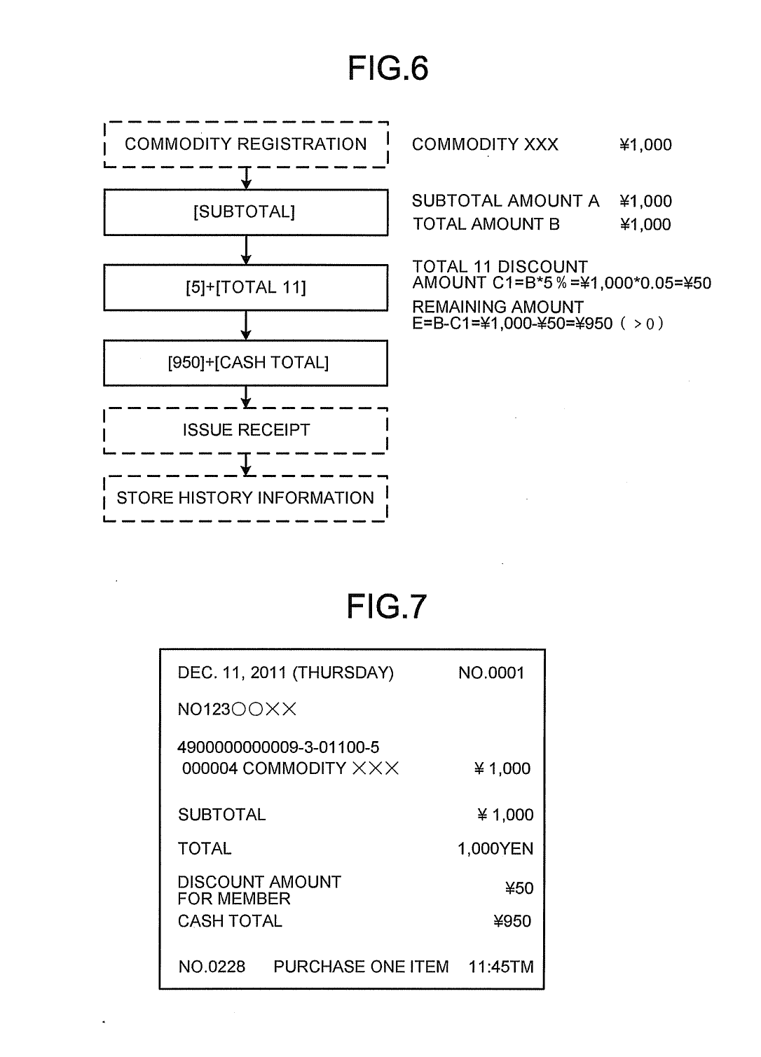

A specific example of the settlement processing having the flow above is described below with reference to FIG. 6-FIG. 10.

FIG. 6 is a flow chart of a first specific example.

If the PLU code of a ¥1,000 commodity XXX is input and the subtotal key 223 is operated in the processing of Act S1, then the subtotal amount A and the total amount B in the processing of Acts S3 and S4 are both ¥1,000.

Then, if ‘5’ is input by the numeric keypad 221 in the processing of Act S5 and the total 11 key 225 is operated, then the total 11 discount amount C1 calculated in the processing of Act S8 is: the total amount B×0.05=¥50.

At this time, the remaining amount calculated in the processing of Act S10 is: the total amount B-the total 11 discount amount C1=¥950(greater than 0), so no need to execute the error processing shown in Act S12.

Then, if ‘950’ is input by the numeric keypad 221 and the cash total key 224 is operated in the processing of Act S5, then the receipt shown in FIG. 7 is issued in the processing of Act S14. The PLU data which is written into the transaction buffer in the said transaction: ‘the commodity XXX ¥1,000’, the subtotal amount A: ‘the subtotal ¥1,000’, the total amount B: ‘the total ¥1,000’, the cash total amount: ‘the cash total ¥950’ and the like are printed on the receipt shown in FIG. 7. Furthermore, for the total 11 discount amount C1, such as ‘the members discount amount ¥50’ is printed to be able to identify that is equivalent to the discount class: ‘the members discount’ which is set for the total 11 key 225.

In addition, the history information containing the PLU data: ‘the commodity XXX ¥1,000’, the subtotal amount A: ‘¥1,000’, the total amount B: ‘¥1,000’, the total 11 discount amount C1: ‘¥50’ and the like are stored in the sales file 32 in the processing of Act S15.

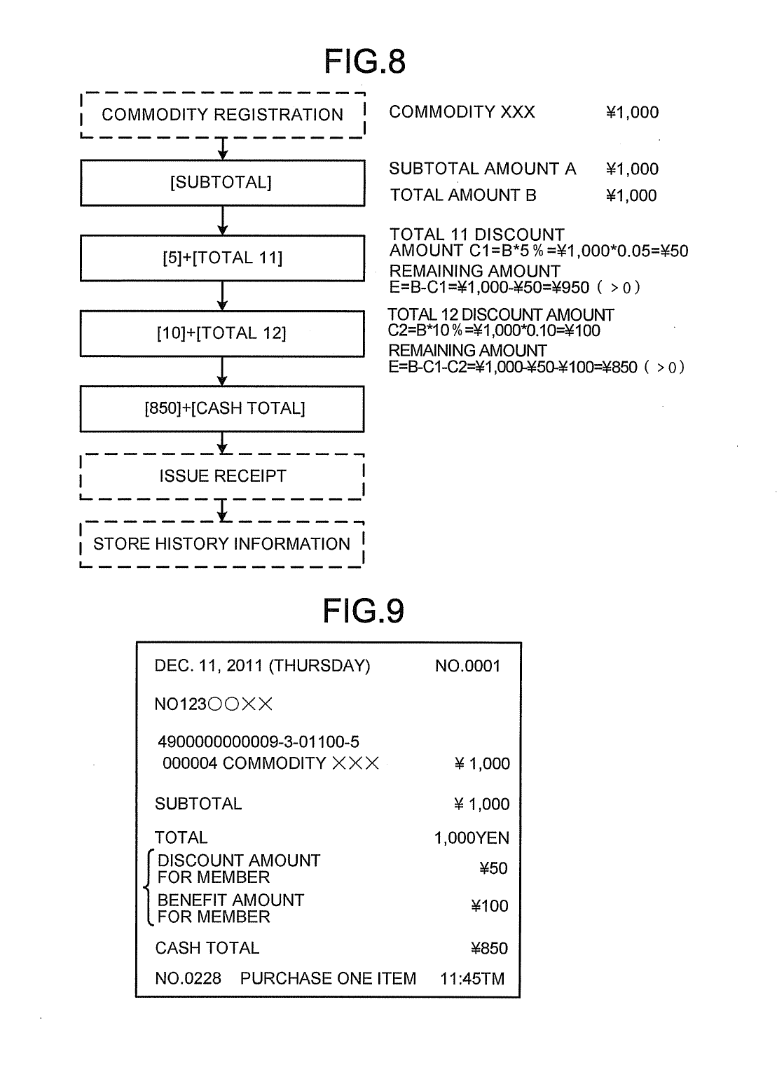

FIG. 8 is a flow chart of a second specific example.

The second specific example is that after the automatic discount is executed by the operation of the total 11 key 225, as described in the first specific example, then additionally, the automatic discount is executed by the operation of the total 12 key 226.

If ‘10’ is input by the numeric keypad 221 and the total 12 key 226 is operated in the processing of Act S5 of immediately after the automatic discount is executed by the operation of the total 11 key 225 in the first specific example, then the total 12 discount amount C2 calculated in Act S8 is: the total amount B×0.05=¥100. At this time, as the remaining amount E calculated in the processing of Act S10 is: the total amount B-the total 11 discount amount C1-the total 12 discount amount C2=¥850 (greater than 0), so no need to execute the error processing described in Act S12.

Then, if ‘850’ is input by the numeric keypad 221 and the cash total key 224 is operated in the processing of Act S5, then the receipt shown in FIG. 9 is issued in the processing of Act S14. The PLU data which is written into the transaction buffer in the said transaction: ‘the commodity XXX ¥1,000’, the subtotal amount A: ‘the subtotal ¥1,000’, the total amount B: ‘the total ¥1,000’, the cash total amount: ‘the cash total ¥850’ and the like are printed on the receipt shown in FIG. 9. Furthermore, for the total 11 discount amount C1, such as ‘the members discount amount ¥50’ is printed to be able to identify that is equivalent to the discount class: ‘the members discount’ which is set for the total 11 key 225, for the total 12 discount amount C2, such as ‘the members benefit amount ¥100’ is printed to be able to identify that is equivalent to the discount class: ‘the members benefit’ which is set for the total 12 key 226. In addition, the history information containing the PLU data: ‘the commodity XXX ¥1,000’ , the subtotal amount A: ‘¥1,000’, the total amount B: ‘¥1,000’, the total 11 discount amount C1: ‘¥50’, the total 12 discount amount C2: ‘¥100 ’ and the like are stored in the sales file 32 in the processing of Act S15.

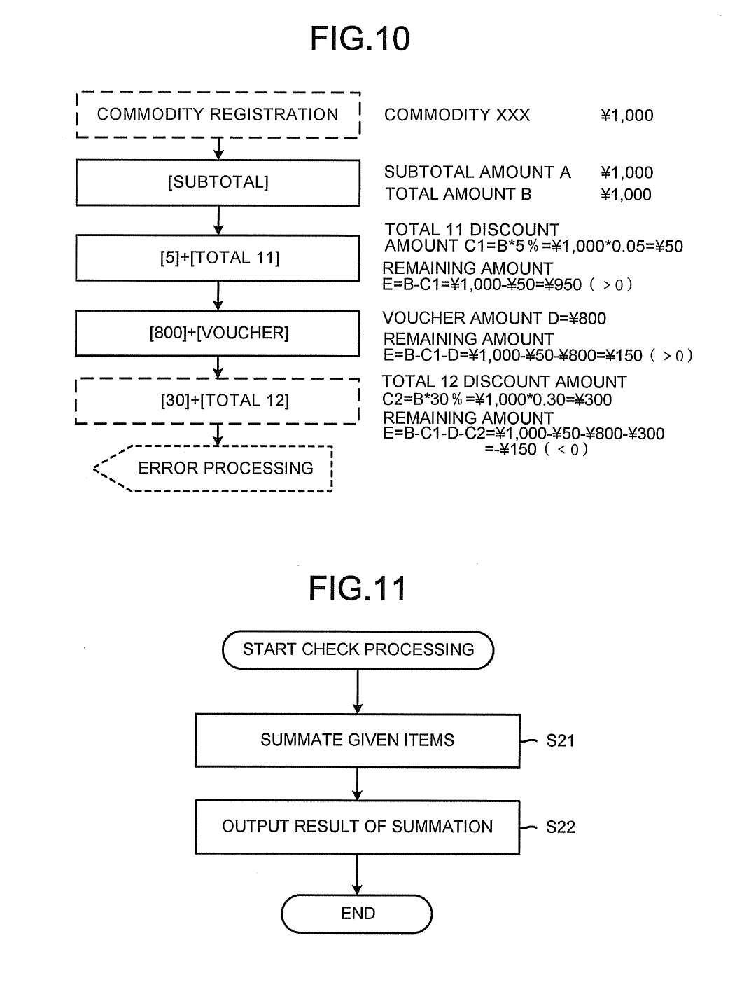

FIG. 10 is a flow chart of a third specific example.

The third specific example is that after the automatic discount is executed by the operation of the total 11 key 225, as described in the first specific example and the second specific example, then additionally, the automatic discount is executed by the operation of the total 12 key 226 and the remaining amount E is negative.

If ‘800’ is input by the numeric keypad 221 and the voucher key 227 is operated in the processing of Act S5 of immediately after the automatic discount is executed by the operation of the total 11 key 225 in the first specific example, then the voucher amount D calculated in Act S8 is ¥800. At this time, as the remaining amount E calculated in the processing of Act S10 is: the total amount B-the total 11 discount amount C1—the voucher amount D=¥150 (greater than 0), so no need to execute the error processing described in Act S12.

Soon after that, if ‘800’ is input by the numeric keypad 221 and the total 12 key 226 is operated in the processing of Act S5, then the total 12 discount amount C2 calculated in Act S8 is: the total amount B×0.30=¥300. At this time, as the remaining amount E calculated in the processing of Act S10 is: the total amount B-the total 11 discount amount C1—the voucher amount D-the total 12 discount amount C2-¥150(smaller than 0), so need to execute the error processing described in Act S12. In the error processing, for example, the message that is ‘the automatic discount calculation by the operation of the total 12 key 226 cannot be carried out’ is displayed on the display 23 of the side of a shop assistant, and the total 12 discount amount C2 is deleted from the transaction buffer.

[Totalizing processing]

Next, the totalizing processing for the amounts and the like contained in the history information stored in the sales file 32 according to given items is described below.

For example, if a key switch (not shown) is operated to indicate the execution of a check report, then the CPU 10 acts in accordance with a totalizing program stored in the memory 11 to realize the flow shown in FIG. 11.

That is, the CPU 10 first totalizes the amounts of specified items with reference to the history information contained in the sales file 32 (Act S21) . Further, the history information as the totalized objects may adapt various styles, for example, including limiting the transaction date and time to be the current date. Further, the totalized items include, for example, the number of the history information of the totalized objects (the total transaction number), the totalized value of the total amount B contained in each history information of the totalized objects (the total sales), the totalized value of the total 11 discount amount C1 contained in each history information of the totalized objects (the total members discount amount), the totalized value of the total 12 discount amounts C2 (the total members benefit amount) and the totalized value of the total voucher amounts D (the total voucher amount).

After the totalizing of each item is ended, the CPU 10 outputs the result of the totalizing (Act S22) and ends the totalizing processing. The output of the result of the totalizing may be displayed on the display 23 of the side of a shop assistant or printed by the receipt printer 25. If you see the output of the result of the totalizing, it is very easy to know how much of the amount of the members discount or the members benefit.

As described above, if the total 11 key 225 or the total 12 key 226 is operated after the subtotal key 223 is operated and the automatic discount calculation is executed for the total amount B of one transaction, then the POS terminal 1 stores the discount amount for being able to identify the class of the discount (the total 11 discount amount or the total 12 discount amount) in the sales file 32. If you references the sales file 32, it may be able to know the class of the discount of the transaction in past settlement processing.

Further, if the execution of the plurality of classes of the discounts is indicated in one transaction, the POS terminal 1 calculates a discount amount based on the total amount B calculated in the processing of Act S4 for each one of the indications. Thus, a correct discount amount may be calculated based on the total amount of the purchased commodities.

Further, the POS terminal 1 issues a receipt on which the discount amount of the discount applied by the operation of the total 11 key 225 or the total 12 key 226 and the class of the discount are printed. The customer can easily know the class of the applied discount by reading the receipt.

Further, in the totalizing processing, the POS terminal 1 totalizes the discount amounts contained in the history information stored in the sales file 32 according to the discount classes and outputs the result of the totalizing. By reading the output of the result of the totalizing, the discount amount can be easily known.

Further, if the execution of price discounts is operated for many times to indicate by the operation of the total 11 key 225 or total 12 key 226 and the like and the totalized amount of price discounts exceeds the total amount B calculated in Act S4, then the POS terminal 1 reports an error. By reporting the error, the occurrence of the inappropriate situation that the transaction cost is negative may prevent.

[Variation]

The embodiment above can be embodied in the forms of a variety of variation embodiments, the examples of which may be as follows:

(1) In the embodiment above, as an example of the settlement processing apparatus, a POS terminal 1 used in a shop is described. However, the components relate to the automatic discount disclosed herein the embodiment above and the like may also be apply to a settlement terminal exclusively used for a card settlement terminal or an others settlement processing apparatus such as an self checkout terminal which is executed a sales processing by the operation of a customer. Further, the components relate to the automatic discount disclosed herein the embodiment above and the like may also be apply to a settlement terminal exclusively used for a settlement processing apparatus in a shop which provide a miscellaneous service in a restaurant or a laundry at the like. In this case, ‘the commodity’ in the embodiment above may replace to ‘the service’.

(2) It is assumed in the embodiment above that the CPU 10 runs the program stored in the memory 11 to achieve the actions of the POS terminal 1. However, the embodiment is not limited to this, the program may also be downloaded to the POS terminal 1 from a given network, or a program which is pre-installed the same function in a storage medium may also be downloaded in the POS terminal 1. The storage medium may be a CD-ROM or a storage medium in any form readable to the POS terminal 1. Further, the function achieved by the pre-installation or download can also be achieved by cooperating with the OS in the POS terminal 1.

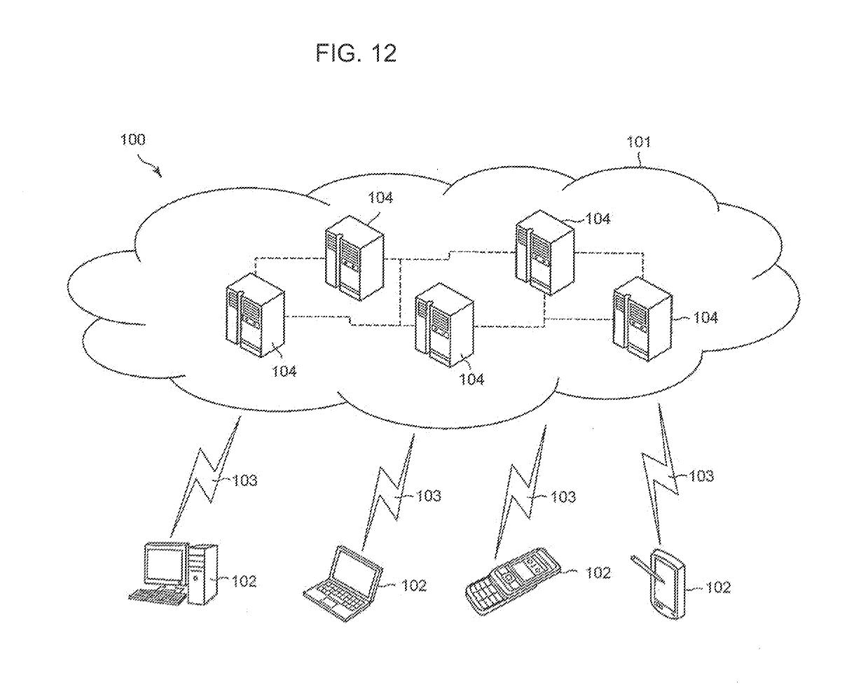

(3) The indication of the discount of the discount amount B by the total 11 key 225 and the total 12 key 226 is exemplarily given in the embodiment above or the variation embodiment described in FIG. 12. However, more keys representing discounts of different classes may also be set. In this case, a file 31 may be set for the discount shown in FIG. 3 to add data according to the number of the keys.

(4) In addition, the functions assumed to be achieved by the POS terminal 1 or part of the components assumed to be arranged on the POS terminal 1 may also be provided on a server in communication connection with the POS terminal 1. For building system by this ways, for example, may be use a cloud calculation. More specifically, software form which is called SaaS (software as a service) is good.

FIG. 12 is a diagram illustrating a settlement processing system using a cloud system.

The settlement processing system 100 includes a cloud 101, a plurality of terminal apparatuses 102, a plurality of communication networks 103 and a plurality of servers 104 communicating with each other. However, there may be one terminal unit 102, one communication network 103 and one server 104.

The terminal unit 102 may communicate with the cloud 101 via the communication network 103. The terminal unit 102 may be the POS terminal described in the embodiment above, and computers such as desktop computer and notebook computer, a cellular phone handset, a PDA (Personal Digital Assistant) or a smart phone in some cases.

The communication network 103 may be an internet, a private network, the NGN (Next Generation Network) and a mobile network in some cases.

In such a settlement processing system 100 in the embodiment above, at least part of the functions assumed to be achieved by the POS terminal 1 or the components assumed to be arranged on the POS terminal 1 are set in the server 104, and the remaining functions or components are set on the terminal 102. Further, the functions or components above may be distributed on a plurality of servers 104.

For example, the server 104 includes at least one of the function of calculating the total amount B (Act S4) described in the embodiment above, the function of calculating the discount amounts C1 and C2 (Act S8) and the component equivalent to the sales file 32 is achieved.

Moreover, the function for realizing the calculating the total amount B, the function for realizing the calculating the discount amounts C1 and C2, the functions equivalent to the sales file 32 that the server 104 is not equipped and the functions or the components for realizing the executing other processing disclosed in the embodiment above are set in the terminal unit 102

While certain embodiments have been described, these embodiments have been presented by way of example only, and are not intended to limit the scope of the invention. Indeed, the novel method or system described herein may be embodied in a variety of other forms. Furthermore, various omissions, substitutions and changes in the form of the novel method or system described herein may be made without departing from the spirit of the invention. The accompanying claims are intended to cover such embodiments or variations thereof as would fall within the scope and spirit of the invention.

What is claimed is:

1. A settlement processing apparatus, comprising:
an information input unit configured to input the information related to a commodity or service;
a total amount calculation unit configured to calculate the total amount of the costs of the commodities or services which is input the information by the information input unit;
a discount indication unit configured to indicate the execution of the discount according to predetermined class; a discount amount calculation unit configured to calculate a discount amount by multiplying the total amount calculated by the total amount calculation unit by a given discount rate, if the discount indication unit indicates the execution of the discount; and
a history storage unit configured to store the discount amount calculated by the discount amount calculation unit for being able to identify the class of the discount, if the settlement of the commodity or service which is input the information by the information input unit is completed.

2. The settlement processing apparatus according to claim 1, wherein
the discount indication unit comprises a plurality of operational keys which indicate the discount of different classes;
the discount amount calculation unit, if the execution of the discount of the plurality of the class by the operational key is indicated in one transaction, calculates a discount amount by multiplying the total amount calculated by the total amount calculation unit by a given discount rate for each indication; and
the history storage unit stores each discount amount calculated by the discount amount calculation unit for being able to identify the class of the discount.

3. The settlement processing apparatus according to claim 2, further comprising:
a receipt issuing unit configured to issue a receipt that the discount amount calculated by the discount amount calculation unit and the class of the discount corresponding to the discount amount are printed.

4. The settlement processing apparatus according to claim 3, further comprising:
a totalizing unit configured to totalize the discount amounts contained in the plurality of the history stored by the history storage unit according to discount classes; and
an output unit configured to output the result of the totalizing carried out by the totalizing unit.

5. The settlement processing apparatus according to claims 2, further comprising:
a notification unit configured to notify an error if the total amount of the discount amount calculated by the discount amount calculation unit for every indication of the execution of the discount exceeds the total amount calculated by the total amount calculation unit when the plurality of the execution of the discount are indicated in one transaction.

6. A settlement processing method, comprising:
accepting the input of the information related to a commodity or service;
calculating a total amount of the costs of the commodities or services which is accepted input of the information by the acceptance;
calculating a discount amount by multiplying the total amount calculated by the total amount calculation unit by a given discount rate, if the execution of the discount of a given class is indicated; and
storing the discount amount calculated by the calculation of the discount amount for being able to identify the class of the discount, if the settlement of the commodity or service which is accepted input the information by the acceptance is completed.

7. A settlement processing system includes a terminal unit and at least one server, comprising:
an information input unit configured to input the information related to a commodity or service;
a subtotal indication unit configured to indicate the execution of a subtotal calculation;
a total amount calculation unit configured to calculate the total amount of the costs of the commodities or services which is input the information by the information input unit, if the execution of a subtotal calculation is indicated by the subtotal indication unit;
a discount indication unit configured to indicate the execution of the discount according to predetermined class;
a discount amount calculation unit configured to calculate a discount amount by multiplying the total amount calculated by the total amount calculation unit by a given discount rate, if the execution of the discount is indicated by the discount indication unit; and
a history storage unit configured to store the discount amount calculated by the discount amount calculation unit for being able to identify the class of the discount, if the settlement of the commodity or service which is input the information by the information input unit is completed; wherein
the server includes at least one of the total amount calculation unit, the discount amount calculation unit and the history storage unit, and
the terminal unit includes the information input unit, the subtotal indication unit, the discount indication unit and any unit of the total amount calculation unit, the discount amount calculation unit and the history storage unit except that the server include.
